(19) United States
(12) Patent Application Publication
(10) Pub. No.: US 2003/0175563 A1
(43) Pub. Date: Sep. 18, 2003

(54) Fuel cell facility and method for operating a fuel cell facility

(76) Inventors: Rolf Bruck, Bergisch Gladbach (DE); Meike Reizig, Erpel (DE); Marcus Beresford, Nr Bridport (GB)

Correspondence Address: LERNER AND GREENBERG, P.A., PATENT ATTORNEY AND ATTORNEYS AT LAW, Post Office Box 2480, Hollywood, FL, 33022, US

(21) Appl. No.: 10/385,761

(22) Filed: Mar. 11, 2003

Related U.S. Application Data
(63) Continuation of application No. PCT/EP01/10326, filed on Sep. 7, 2001.

(30) Foreign Application Priority Data
Sep. 11, 2000 (DE) 100 44 786.4

(51) Int. Cl. H01M 8/06; H01M 8/04

(52) U.S. Cl. 429/19; 429/34; 429/24; 429/22; 429/25; 429/17

(57) ABSTRACT

A method is provided for operating a fuel cell facility, especially for motor vehicles, including a fuel cell device, a reformer and at least one hydrogen storage device forming part of a system for receiving and discharging hydrogen. The hydrogen is distinguished by fast absorption and desorption kinetics in such a way that hydrogen from exhaust gas, from a combustion engine for example, can also be concentrated and/or stored by simply passing the waste gas through the hydrogen storage device. A fuel cell facility is also provided.

### CROSS-REFERENCE TO RELATED APPLICATION

This application is a continuation of copending International Application No. PCT/EP01/10326, filed Sep. 7, 2001, which designated the United States and was not published in English.

### BACKGROUND OF THE INVENTION

### FIELD OF THE INVENTION

The invention relates to a method for operating a fuel cell facility, in particular for motor vehicles. The invention also relates to an associated fuel cell facility having a reformer and a storage system for taking up and releasing hydrogen.

Storing hydrogen in liquid or gaseous form entails a high level of outlay. For example, liquefaction of 1 kg of hydrogen requires approximately 10 kWh of current. By contrast, the known systems for storing hydrogen in the form of a hydride have the advantage of an increased hydrogen density-compared to liquid and gaseous hydrogen (density of the hydrogen as hydride: 103 g/l; as liquid: 71 g/l and as gas: 31 g/l). An example of a suitable hydride storage material is magnesium.

Moreover, U.S. Pat. No. 6,030,724 has disclosed what is known as the “Ovonic Hydrogen Technology” with an Ovonic alloy for forming the hydride. In that case, it is possible to fill a storage device which is coated with that alloy, for example a metallic, ceramic or oxidic honeycomb body which is known from International Publication No. WO 91/01807, corresponding to U.S. Pat. No. 5,045,403, or International Publication No. WO 91/01178, corresponding to U.S. Pat. No. 5,403,559, with hydride within a short time. The good absorption and desorption kinetics, for example of the Ovonic hydrogen storage system, which are initiated within seconds, can be used not only for rapid refueling of the storage device at a refueling pump but also for hydrogen enrichment from an exhaust gas and therefore for gas purification.

Recently, intensive research and development has been directed at commercial use of the environmentally friendly fuel cell technology in mobile applications as well, in particular in motor vehicles. In that context, there are known mobile fuel cell facilities which are operated with pure hydrogen and those which include a reformer, to which a feed fluid, for example fuels such as gasoline, are fed. That fuel is converted in a reforming reaction in such a way that a reformer gas or fuel gas is obtained. That gas contains free or bound hydrogen and is used to supply fuel cells which are preferably disposed to form a stack as is known, for example, from European Patent EP 0 596 366 B1, corresponding to U.S. Pat. No. 5,478,662 and U.S. Pat. No. Re 36,148.

However, in the cold-starting phase of a motor vehicle, the reformer initially supplies a reformer gas which is too greatly contaminated to be used as fuel gas in the stack. In that context, it is known to add supplementary hydrogen to the reformer gas, for example from a hydrogen tank and/or a hydrogen storage device in which hydrogen is stored in gas form, in liquid form or in the form of a hydride. The storage of hydrogen in liquid or gas form is preferred in view of the potential risk of storing hydrogen as a hydride, and that method of storage also takes up less space.

When the motor vehicle is operating, load changes often occur, but larger quantities of hydrogen are only made available to the stack with a very considerable delay as a result of the feed fluid mass flow in the feed fluid feed line to the reformer being increased. Therefore, if the stack is to be operated under dynamic conditions, as is required for any mobile application, a hydrogen storage device which rapidly releases hydrogen that can be fed to the reformer gas when required, ensuring that the reformer gas can be used as hydrogen-rich fuel gas, is necessary in addition to the reformer.

Finally, a further problem arises when the reformer is being run up, specifically due to the fact that low-hydrogen reformer gas, which is not suitable for feeding into the stack as fuel gas, can be discharged directly to the environment, but does not satisfy the statutory emissions requirements.

### SUMMARY OF THE INVENTION

It is accordingly an object of the invention to provide an improved fuel cell facility, in particular for motor vehicles, and a method for operating a fuel cell facility, which overcome the hereinafore-mentioned disadvantages of the heretofore-known devices and methods of this general type.

With the foregoing and other objects in view there is provided, in accordance with the invention, a fuel cell facility, comprising a reformer and at least one hydrogen storage device connected to the reformer for storing hydrogen, preferably in hydride form. The at least one hydrogen storage device reversibly accumulates hydrogen and releases hydrogen again, depending on operating conditions.

With the objects of the invention in view, there is also provided a fuel cell facility for motor vehicles, comprising a hydrogen storage device. The hydrogen storage device is operable for: storing a quantity of energy amounting to between 0.1 and 5 kW/h and/or providing a quantity of energy consumed within a first 5 to 10 minutes of operation after cold-starting the motor vehicle.

With the objects of the invention in view, there is also provided a method for operating a fuel cell facility, in particular for motor vehicles. The method comprises passing at least a partial stream of a fluid, such as exhaust gas, guided in the fuel cell facility, through a hydrogen storage device. The fuel cell facility also has a reformer.

Since the speed of the absorption/desorption kinetics represents a critical point, it is preferable to use a hydrogen storage device, accumulator or reservoir which initiates the absorption/desorption within seconds. In this context, the term “initiates within seconds” is used to characterize a hydrogen storage device having absorption/desorption kinetics which are within the range of an Ovonic hydrogen storage device as described in the introduction, which has proven to have a particularly high performance in the context of the invention.

The fluid which is introduced into the hydrogen storage device is in particular the hydrogen-containing exhaust gas from an upstream reformer, which is also referred to below as reformer gas. This gas is used as fuel gas for operation of a fuel cell stack if it has a sufficient hydrogen content.

A fuel cell facility having a reformer and at least two hydrogen storage devices can advantageously be operated with pure hydrogen, for example if the storage devices are connected in series, which brings considerable advantages. For example, the reformer gas should only be introduced into the fuel cell stack as fuel gas at the optimum operating point of the reformer, since it previously contained too little hydrogen in the mixture. Therefore, the reformer gas is guided past the fuel cell stack while the facility is starting up. Other off-gases, such as the product gas from the fuel cell stack, from a heat exchanger and/or a humidifier, can also be passed through a further hydrogen storage device and be used, for example, for heating purposes or to regenerate unused fuel.

The desorption of the hydrogen in the hydrogen storage device can be initiated, for example, by a reduction in the pressure and/or a change in the temperature. Accordingly, the absorption is started by increasing the pressure and/or changing the temperature. When a modified, heatable catalytic converter is used as the hydrogen storage device, the operating function of the hydrogen storage device can also be controlled through the use of a current-free circuit.

A change in pressure can also be achieved, for example, by adjusting corresponding valves, flaps or cocks connected downstream of the hydrogen storage device.

As mentioned above, the quantity of energy which can be stored in a hydrogen storage device of a fuel cell facility is advantageously approximately between 0.1 and 5 kW/h, preferably 1 kW/h. It is also advantageous if the quantity of energy which is required for the first 5 to 10 minutes of driving time after a cold start is stored in the hydrogen storage device.

According to a preferred embodiment of the fuel cell facility having a reformer, at least one hydrogen storage device is connected to the reformer, e.g. upstream of the fuel cell stack and/or between the gas outlet of the reformer and/or of the fuel cell stack and the environment. For example, it is possible for at least one hydrogen storage device to supply the stack with hydrogen or hydrogen-containing fuel gas by desorption while the reformer is being run up and is as yet unable to supply usable fuel gas. The energy which the hydrogen storage device requires for the desorption may be supplied externally in this case, for example through an energy storage device such as a battery.

A further hydrogen storage device can be used during the starting phase for catalytic conversion and/or gas purification of the reformer exhaust gas, so that the hydrogen is separated out of the reformer exhaust gas, in which case the heat of reaction which is produced can even be utilized, for example to preheat the reformer, before the purified reformer exhaust gas is discharged to the environment, if appropriate with monitoring by a sensor unit, for example a gas sensor, and through a further catalytic converter. The hydrogen storage device can therefore also be used to preheat the reformer when the fuel cell facility is being run up.

According to an advantageous embodiment, at least one hydrogen storage device is connected downstream of the fuel cell stack, so that this storage device can fulfill a dual function if it is used as both a storage device and a catalytic converter. This is made possible, for example, by a combination of a catalytically active area in a honeycomb body and an area of a honeycomb body which acts as a hydrogen storage device.

The unique capacity of a hydrogen storage device to rapidly take up and release hydrogen allows this application. That is because in a mobile system it is inconceivable for the exhaust gas to have a long residence time in a module, such as in a hydrogen storage device.

According to a further preferred embodiment, two hydrogen storage devices are combined through a bypass system, so that in continuous operation a storage device which is full is decoupled from the reformer gas and the desorption conditions are set, while at the same time reformer gas flows into a second hydrogen storage device, for example by a flap being switched over. In this way, the latter storage device can be filled with hydrogen while the former storage device is releasing hydrogen to the process gas, for example in the event of a load change. The use of a combination of at least two hydrogen storage devices of this type with sufficient capacity makes it possible to operate with pure hydrogen. Nevertheless, it is also possible, however, for a partial stream from the reformer to be admixed with the fuel as carrier gas for this purpose.

The product gas, for example from the anodes of the fuel cell stack, may still contain up to 20% by volume of unused hydrogen, wherein the term “% by volume” relates to the quantity of hydrogen introduced. Therefore, it can contribute to increasing the overall efficiency of the system if the hydrogen-containing anode exhaust gas is also passed through a hydrogen storage device and in this way unused hydrogen is regenerated.

As an alternative or in combination with this measure, the product gas can also be catalytically converted in an exhaust-gas catalytic converter. Purified exhaust gases can then be discharged to the environment. It is possible for the heat generated by the catalytic conversion to be discharged in a heat exchanger through which, by way of example, the feed fluid for the reformer is passed.

The anode-side product gas from the fuel cell stack preferably flows into a hydrogen storage device, which in turn may be directly connected to the fuel-gas line leaving the hydrogen storage device or may be disposed externally.

Preferably, according to the invention, for example with a combined configuration of a plurality of hydrogen storage devices, the fuel cell facility is supplemented by a control system, in particular with sensor units. The sensors thereof record at least the hydrogen concentration, temperature and/or composition of the gas mixture, for example, in the lines upstream and downstream of a hydrogen storage device, upstream of a gas outlet to the environment, upstream of the entry of the fuel gas to the fuel cell stack, and determine and adjust the position of the valves or flaps of the fuel cell facility which is optimum for the instantaneous power demand of the fuel cell stack. Therefore, the hydrogen partial pressure in the process gas, i.e. reformer or fuel gas, can be dynamically matched to the power demand of the fuel cell stack. In particular, the hydrogen storage device is advantageously used during a cold start and for power peaks.

According to a further configuration, the Ovonic alloy, which forms the hydride during refueling with hydrogen, is applied, as a component of a coating or as a coating, to a metallic honeycomb body or to a part of a honeycomb body. The alloy may also be applied as a bulk bed in the passages of the honeycomb body. The coating may also, by way of example, be a washcoat, i.e. a material contained in an aluminum oxide. Suitable metallic honeycomb bodies are, inter alia, catalytic converters which are known from International Publication No. WO 91/01807, corresponding to U.S. Pat. No. 5,045,403, or International Publication No. WO 91/01178, corresponding to U.S. Pat. No. 5,403,559, having a cell density of up to 1600 cpsi (cells per square inch). According to a preferred configuration, these honeycomb bodies are electrically heatable.

The term “fuel cell facility” refers to the entire fuel cell system which, by way of example, may also include two subsystems, i.e. systems which can be operated separately and either form two separate fuel cell stacks or are integrated in a single housing. These subsystems each have at least one stack with a fuel cell unit, corresponding process-gas feed passages, such as, for example, the fuel-gas line, in which the hydrogen storage device may be located, and process-gas discharge passages, a cooling system with cooling medium and all of the fuel-cell stack peripherals, optionally or in combination: reformer, compressor, blower, heater for process-gas preheating, inter alia.

Other features which are considered as characteristic for the invention are set forth in the appended claims.

Although the invention is illustrated and described herein as embodied in a fuel cell facility and a method for operating a fuel cell facility, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic and block diagram of a fuel cell facility according to the invention;

FIG. 2 is a schematic and block diagram of a fuel cell facility as shown in FIG. 1 with two hydrogen storage devices;

FIG. 3 is a schematic and block diagram of a further embodiment of the fuel cell facility according to the invention, which can be operated with pure hydrogen; and

FIG. 4 is a schematic and block diagram of a fuel cell facility with two hydrogen storage devices, which are also used for gas purification.

### DESCRIPTION OF THE PREFERRED EMBODIMENTS

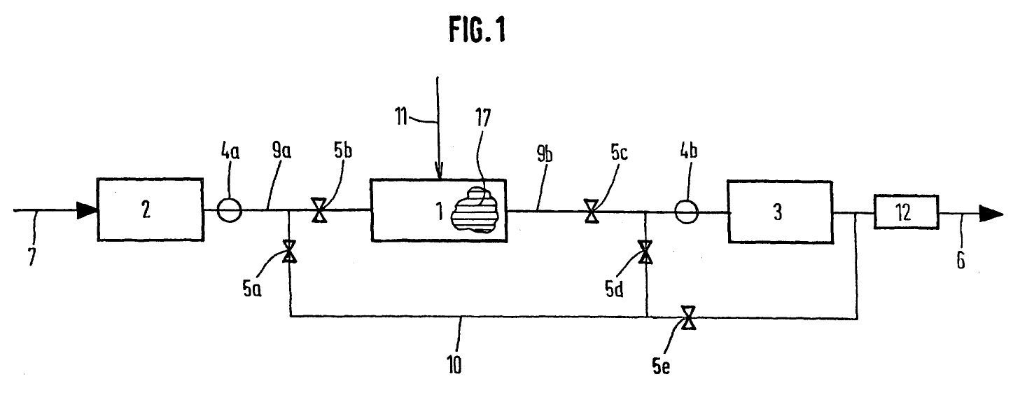

Referring now to the figures of the drawings in detail and first, particularly, to FIG. 1 thereof, there is seen a schematic and block diagram of a fuel cell facility according to the invention, having a reformer 2 in which a reforming reaction takes place. A feed fluid, for example fuels such as gasoline, is fed to the reformer 2 through a feed-fluid feed line 7, and in the reformer this feed fluid is converted into a reformer gas. The reformer gas, which during operation is a hydrogen-rich fuel gas, is fed to a fuel cell stack 3. In the event of a load change, in particular in the event of an increased demand, the fuel gas is fed to the fuel cell stack 3 through a first line section 9a and a second line section 9b, between which a hydrogen storage device 1 is disposed. During normal operation of the motor vehicle, the feed of the fuel gas to the fuel cell stack 3 is effected through a bypass line 10. Both feed options, which can also be used cumulatively in partial streams, are produced with the aid of flaps, cocks and/or valves 5a to 5e depending on the power demand.

In addition, particularly in the event of a load change, an additional partial stream of hydrogen can be provided to the fuel cell stack 3 from the hydrogen storage device 1 through the second line section 9b by the use of desorption. After a load change, it is also possible to provide a lag time, the duration of which, once again, can be set, for example, as a function of load, through the use of the hydrogen storage device 1 and the second line section 9b.

During a starting phase, when the reformer 2 is being run up, the valves 5a to 5e preferably have the following setting:

A valve 5a leading to the bypass line 10 of the reformer gas, a valve 5c between the hydrogen storage device 1 and the fuel cell stack 3 and a valve 5e leading from the bypass line 10 through a catalytic converter 12 and an exhaust pipe 6 into the environment, are open. Therefore, the reformer gas which cannot be used as fuel gas during the starting phase, having been substantially purified by the catalytic converter 12, can be discharged to the environment. The catalytic converter 12 is preferably heatable in order to ensure that the gas is purified right from the outset.

Desorbed hydrogen from the hydrogen storage device 1 is fed to the fuel cell stack 3 as fuel gas through the second line section 9b even during the starting phase of the motor vehicle. In this case, valves 5band 5d remain closed. It is possible to determine when the reformer gas has a sufficiently high concentration of hydrogen to be used as a fuel gas, through the use of a first sensor device 4a, which is disposed downstream of the reformer 2. As an alternative or in combination with this measure, it is possible to protect against poisoning of the fuel cell stack 3 through the use of a second sensor device 4b disposed upstream of the fuel cell stack 3. In this case, the valve 5d would be opened first and the valve 5e closed. The position of the valve 5c depends on whether or not hydrogen has to be fed to the fuel cell stack 3, for example due to a load change which is just additionally taking place, by desorption from the hydrogen storage device 1.

In the hydrogen storage device 1, either hydrogen is extracted from the reformer gas or hydrogen is fed to the reformer gas, as required, when it is being passed through the hydrogen storage device (this process can be controlled by adjusting the operating temperature of the hydrogen storage device 1 and/or by adjusting the pressure). At least one of the two sensor devices 4a or 4b disposed in the line sections 9a, 9b therefore measures the hydrogen concentration, the gas composition and/or the temperature of the gas mixture. If in the process it is established, for example, that the reformer gas or fuel gas contains too little hydrogen for the instantaneous power demand imposed on the fuel cell stack 3, by way of example the temperature in the hydrogen storage device 1 may be increased until the desorption commences and the hydrogen storage device 1 releases hydrogen to the reformer gas or fuel gas. As an alternative or cumulative measure, it is also possible for hydrogen to be supplied to the hydrogen storage device 1 from the outside through a refueling line 11.

Gas-purification measures may also be integrated in the hydrogen storage device 1, so that in particular carbon monoxide, nitrogen oxides and/or hydrocarbons from the reformer gas or fuel gas can be oxidized, while in another zone of the hydrogen storage device 1 hydrogen is being absorbed from the reformer gas or fuel gas. Therefore, the sensor devices 4a and/or 4b should not be restricted just to measuring the hydrogen concentration, but rather may also be equipped with further gas, pressure and/or temperature sensors. At least part of the hydrogen storage device 1 may be disposed on a honeycomb body 17 as a support.

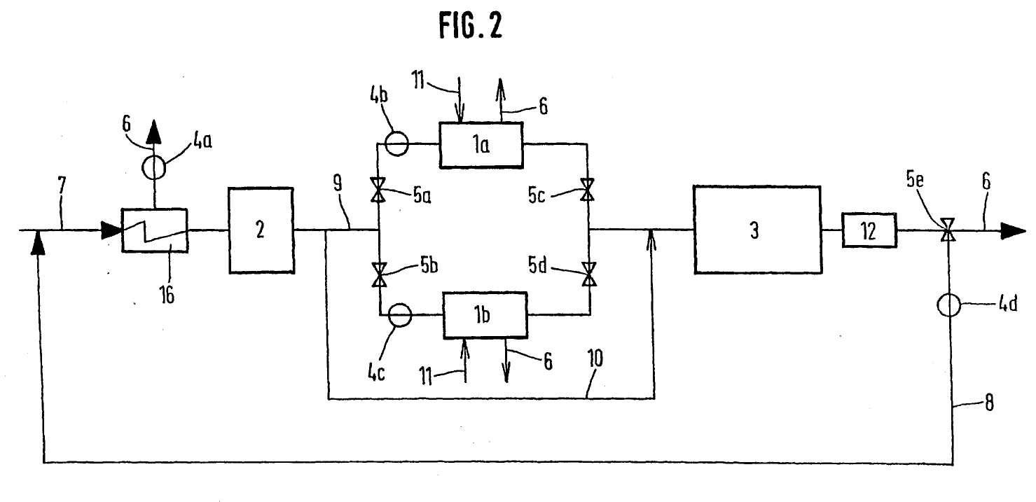

FIG. 2 shows a schematic and block diagram of a fuel cell facility as shown in FIG. 1, but with first and second hydrogen storage devices 1a, 1b which can either be introduced as alternatives (i.e. in parallel) or simultaneously (i.e. in series) into the line 9 from the reformer 2 to the fuel cell stack 3 or may, if desired, not be introduced into this line 9 at all. Once again, the fuel gas can be passed through either one or both hydrogen storage devices 1a, 1b through the use of valves 5a to 5e. A bypass line 10 once again allows reformer gas or fuel gas to be supplied directly to the fuel cell stack 3. Thus far, the principle of the fuel cell facility shown in FIG. 2 corresponds to that shown in FIG. 1 and, by way of example, the second hydrogen storage device 1b can also be used for gas purification in the “absorption”, i.e. hydrogen uptake, mode, while the first hydrogen storage device 1a is then used for enriching the levels of hydrogen in the fuel gas in the “desorption” mode, e.g. at 300° C., or vice versa.

Moreover, product gas, which may still contain up to 20% of unused hydrogen, can be returned to the feed-fluid feed line 7, for example on the anode side, through a product-gas line 8. The valves 5a to 5e and sensor devices or units 4a to 4d can be opened and closed in such a manner that they can be dynamically adjusted in this respect. A heat exchanger 16 is connected in the line 7.

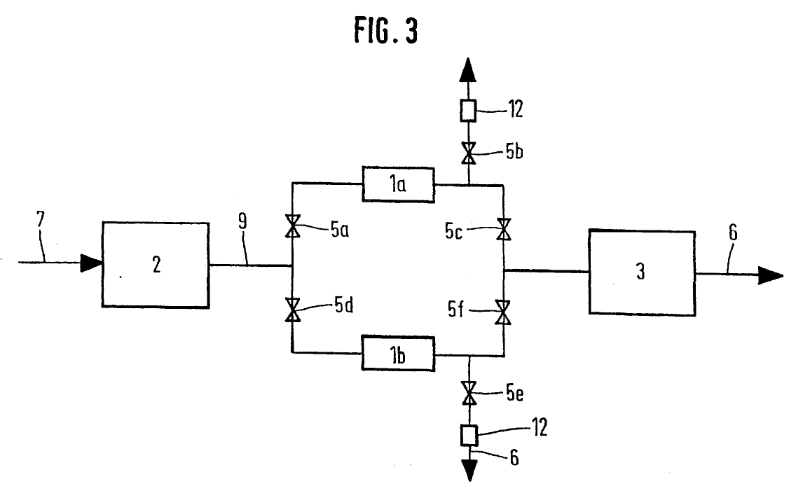

FIG. 3 shows a schematic and block diagram of a further embodiment of the fuel cell facility according to the invention, which can be operated with pure hydrogen absorbed from the reformer gas. Two hydrogen storage devices 1a and 1b, each of which is operated through the use of valves 5a to 5f, are disposed between the reformer 2 and the fuel cell stack 3 which are connected through feed lines 9.

By way of example, the valves 5a to 5f may be switched as follows:

Valves 5a, 5b and 5f are closed and valves 5c, 5d and 5e are open, so that the hydrogen storage device 1a desorbs hydrogen and thereby supplies the fuel cell stack 3, while the hydrogen storage device 1b absorbs hydrogen. In the case of operation with pure hydrogen, all of the fuel cell stack structures which are suitable for this operating method (see the “dead-end system” of European Patent EP 0 596 366 B1, corresponding to U.S. Pat. No. 5,478,662 and U.S. Pat. No. Re 36,148, or a closed system with purging) can be used.

Reformer, fuel or product gases can be discharged to the environment as exhaust gases through various exhaust pipes 6. By way of example, when the valve 5b is switched to the open position, an exhaust gas from the hydrogen storage device 1a is discharged to the environment. A catalytic converter 12 which catalytically converts and purifies the exhaust gas may be disposed in each exhaust pipe 6. Moreover, waste heat from this catalytic converter can be made usable, in particular extracted, and fed to another module of the fuel cell facility, for example to the feed fluid and therefore reformer 2, through the heat exchanger 16 as illustrated in FIG. 2.

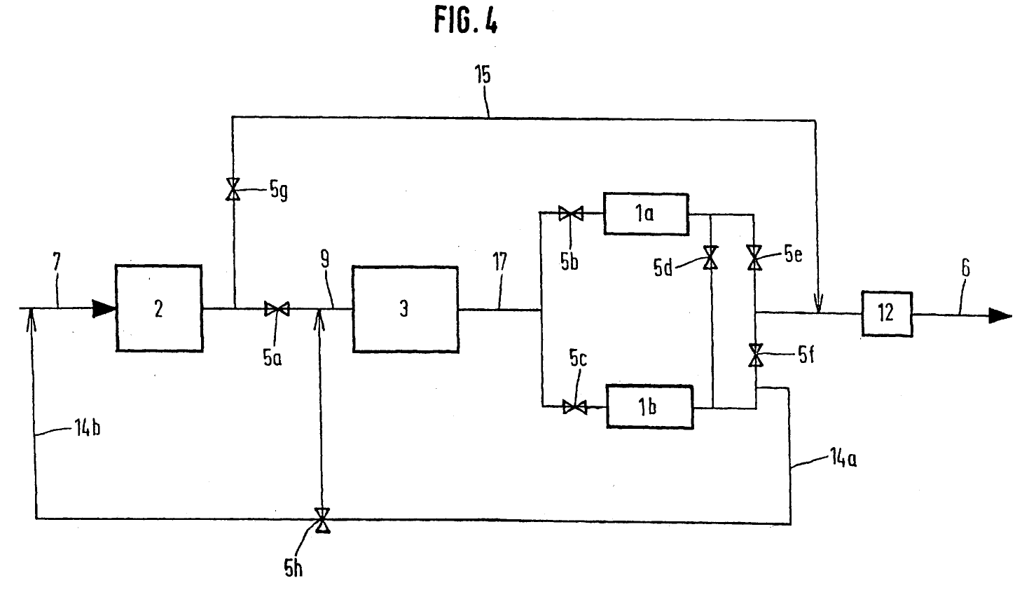

Finally, FIG. 4 shows a further schematic and block diagram of a fuel cell facility, once again with two hydrogen storage devices 1a, 1b, which can also be used for gas purification. In this case, each hydrogen storage device 1a, 1b can be operated in bypass mode. Once again, valves 5a to 5h are provided as control measures. The figure also shows a reformer 2 and a fuel cell stack 3, which are connected to one another through a feed line 9. Used fuel gas from the fuel cell stack 3 is passed into the hydrogen storage devices la and/or 1b through a line section 17, depending on the position of the valves 5b and 5c. A bypass line 15 corresponds to the bypass line 10 shown in FIG. 1 and is used to allow reformer gas to be discharged to the environment during the starting phase. Highly concentrated hydrogen can be fed either directly to the fuel cell stack 3 or, through the feed-fluid line 7, into the reformer 2, through return lines 14a, 14b. When the motor vehicle is starting up, the hydrogen which has been stored in the hydrogen storage devices 1a, 1b is sufficient to bridge the period of operation of the fuel cell stack 3 until the optimum operating point of the reformer is reached.

The invention relating to a method for operating a fuel cell facility and to an associated fuel cell facility is suitable in particular for mobile use in motor vehicles. The hydrogen storage devices 1a, 1b used in the fuel cell facility are, moreover, distinguished by rapid absorption and desorption kinetics, so that it is also possible for hydrogen from the exhaust gas from an internal combustion engine to be enriched and/or stored by simply passing the exhaust gas through the hydrogen storage devices 1, 1a, 1b.

We claim:

1. A fuel cell facility, comprising:
a reformer; and
at least one hydrogen storage device connected to said reformer for storing hydrogen in hydride form, said at least one hydrogen storage device reversibly accumulating hydrogen and releasing hydrogen again, depending on operating conditions.

2. A fuel cell facility for motor vehicles, comprising:
a hydrogen storage device, said hydrogen storage device operable for at least one of:
storing a quantity of energy amounting to between 0.1 and 5 kW/h, and
providing a quantity of energy consumed within a first 5 to 10 minutes of operation after cold-starting the motor vehicle.

3. The fuel cell facility according to claim 1, wherein said at least one hydrogen storage device is a catalytically active hydrogen storage device also being usable for gas purification.

4. The fuel cell facility according to claim 2, wherein said hydrogen storage device is a catalytically active hydrogen storage device also being usable for gas purification.

5. The fuel cell facility according to claim 1, which further comprises a fuel cell stack, and lines for feeding hydrogen from said at least one hydrogen storage device to said fuel cell stack.

6. The fuel cell facility according to claim 2, which further comprises a fuel cell stack, and lines for feeding hydrogen from said hydrogen storage device to said fuel cell stack.

7. The fuel cell facility according to claim 1, which further comprises a line for introducing at least some reformer gas from said reformer into said at least one hydrogen storage device.

8. The fuel cell facility according to claim 2, which further comprises a reformer, and a line for introducing at least some reformer gas from said reformer into said hydrogen storage device.

9. The fuel cell facility according to claim 1, which further comprises a fuel cell stack, and a bypass line for guiding at least some reformer gas from said reformer past said at least one hydrogen storage device directly into said fuel cell stack.

10. The fuel cell facility according to claim 2, which further comprises a reformer, a fuel cell stack, and a bypass line for guiding at least some reformer gas from said reformer past said hydrogen storage device directly into said fuel cell stack.

11. The fuel cell facility according to claim 1, which further comprises a catalytic converter, a fuel cell stack, and a bypass line for guiding at least some reformer gas from said reformer past said at least one hydrogen storage device directly into said fuel cell stack and through said catalytic converter into the environment.

12. The fuel cell facility according to claim 2, which further comprises a catalytic converter, a reformer, a fuel cell stack, and a bypass line for guiding at least some reformer gas from said reformer past said hydrogen storage device directly into said fuel cell stack and through said catalytic converter into the environment.

13. The fuel cell facility according to claim 1, which further comprises a catalytic converter, and a bypass line for guiding at least some reformer gas from said reformer past said at least one hydrogen storage device and through said catalytic converter into the environment.

14. The fuel cell facility according to claim 2, which further comprises a catalytic converter, a reformer, and a bypass line for guiding at least some reformer gas from said reformer past said hydrogen storage device and through said catalytic converter into the environment.

15. The fuel cell facility according to claim 1, wherein said at least one hydrogen storage device has at least one of an absorption and desorption reaction of a few seconds.

16. The fuel cell facility according to claim 2, wherein said hydrogen storage device has at least one of an absorption and desorption reaction of a few seconds.

17. The fuel cell facility according to claim 1, wherein said at least one hydrogen storage device is at least two hydrogen storage devices, and valves selectively connect said at least two hydrogen storage devices in series and in parallel.

18. The fuel cell facility according to claim-2, wherein said hydrogen storage device is one of at least two hydrogen storage devices, and valves selectively connect said at least two hydrogen storage devices in series and in parallel.

19. The fuel cell facility according to claim 1, wherein said at least one hydrogen storage device is at least two hydrogen storage devices, a fuel cell stack is connected to said at least two hydrogen storage devices, and valves switch said fuel cell stack for operation with pure hydrogen.

20. The fuel cell facility according to claim 2, wherein said hydrogen storage device is one of at least two hydrogen storage devices, a fuel cell stack is connected to said at least two hydrogen storage devices, and valves switch said fuel cell stack for operation with pure hydrogen.

21. The fuel cell facility according to claim 1, which further comprises at least one sensor device for measuring at least one of composition, hydrogen partial pressure and temperature of fluids each being guided in the fuel cell facility.

22. The fuel cell facility according to claim 2, which further comprises at least one sensor device for measuring at least one of composition, hydrogen partial pressure and temperature of fluids each being guided in the fuel cell facility.

23. The fuel cell facility according to claim 1, which further comprises a fuel cell stack, and at least one of valves and further controls for dynamically matching a quantity of hydrogen in fuel gas to a power demand of said fuel cell stack.

24. The fuel cell facility according to claim 2, which further comprises a fuel cell stack, and at least one of valves and further controls for dynamically matching a quantity of hydrogen in fuel gas to a power demand of said fuel cell stack.

25. The fuel cell facility according to claim 1, wherein at least part of said at least one hydrogen storage device is disposed on a honeycomb body as a support.

26. The fuel cell facility according to claim 2, wherein at least part of said hydrogen storage device is disposed on a honeycomb body as a support.

27. The fuel cell facility according to claim 1, which further comprises a refueling line for feeding hydrogen to said at least one hydrogen storage device from outside.

28. The fuel cell facility according to claim 2, which further comprises a refueling line for feeding hydrogen to said hydrogen storage device from outside.

29. A motor vehicle fuel cell facility, comprising:
a reformer; and
at least one hydrogen storage device connected to said reformer for storing hydrogen in hydride form, said at least one hydrogen storage device reversibly accumulating hydrogen and releasing hydrogen again, depending on operating conditions.

30. A method for operating a fuel cell facility, which comprises:
passing at least a partial stream of a fluid guided in the fuel cell facility through a hydrogen storage device.

31. The method according to claim 30, which further comprises running up a reformer in the fuel cell facility, and subsequently passing at least some reformer gas through the hydrogen storage device.

32. The method according to claim 30, which further comprises obtaining hydrogen at least partly by desorption from the hydrogen storage device, and feeding the hydrogen to a fuel cell stack of the fuel cell facility as fuel gas.

33. The method according to claim 32, which further comprises operating the fuel cell stack at least from time to time with pure hydrogen.

34. The method according to claim 33, which further comprises operating the fuel cell stack entirely with pure hydrogen.

35. The method according to claim 30, which further comprises passing at least some product gas released from a fuel cell stack of the fuel cell facility through the hydrogen storage device.

36. The method according to claim 30, which further comprises passing at least some product gas released from a fuel cell stack of the fuel cell facility through the hydrogen storage device and through a catalytic converter.

37. The method according to claim 30, which further comprises passing at least some product gas released from a fuel cell stack of the fuel cell facility through a catalytic converter.

38. The method according to claim 30, which further comprises adjusting at least one of temperature and pressure in the hydrogen storage device with at least one sensor device, for dynamically feeding quantities of hydrogen to be matched to an instantaneous power demand, to a fuel cell stack of the fuel cell facility by desorption or absorption of hydrogen in the hydrogen storage device.

39. The method according to claim 30, which further comprises controlling pressure in the hydrogen storage device by adjusting downstream valves.

40. The method according to claim 30, which further comprises using the hydrogen storage device during a cold start and in the event of power peaks.

41. The method according to claim 30, which further comprises providing a reformer upstream of the hydrogen storage device, providing a fuel cell stack downstream of the hydrogen storage device, providing a catalytic converter downstream of the fuel cell stack, and utilizing waste heat from the catalytic converter to preheat a feed fluid fed to the reformer.

42. The method according to claim 41, which further comprises carrying out the step of utilizing the waste heat from the catalytic converter to preheat the feed fluid fed to the reformer, during a cold start of-a motor vehicle.
